(19) United States
(12) Patent Application Publication
(10) Pub. No.: US 2018/0119623 A1
(43) Pub. Date: May 3, 2018

(54) APPARATUS FOR CONTROLLING A GASOLINE-DIESEL COMPLEX COMBUSTION ENGINE AND A METHOD USING THE SAME

(71) Applicants: HYUNDAI MOTOR COMPANY, Seoul (KR); Seoul National University R&DB Foundation, Seoul (KR)

(72) Inventors: Hyunsung Jung, Anyang-si (KR); Yo Han Chi, Seongnam-si (KR); Kyoungdoug Min, Seoul (KR); Jeongwoo Lee, Seoul (KR); Sanghyun Chu, Seoul (KR)

(73) Assignees: HYUNDAI MOTOR COMPANY, Seoul (KR); Seoul National University R&DB Foundation, Seoul (KR)

(21) Appl. No.: 15/378,805

(22) Filed: Dec. 14, 2016

(30) Foreign Application Priority Data
Nov. 2, 2016 (KR) 10-2016-0145020

(51) Int. Cl. F02D 41/00; F02B 31/00

(52) U.S. Cl. CPC F02D 41/0002; F02B 31/00; F02D 2200/024; F02B 2031/006; F02D 2200/101; F02D 41/0025

(57) ABSTRACT

An apparatus for controlling a gasoline-diesel complex combustion engine may include an engine generating driving torque by burning gasoline fuel and diesel fuel; a driving information detector for detecting driving information; a swirl pipe disposed in a combustion chamber, wherein gasoline fuel introduced through the swirl pipe generates a flow in a swirl direction in the combustion chamber; a tumble pipe disposed in the combustion chamber, wherein gasoline fuel introduced through the tumble pipe generates a flow in a tumble direction in the combustion chamber; a swirl gasoline injector and a tumble gasoline injector disposed in the swirl pipe and the tumble pipe for injecting gasoline fuel into the combustion chamber, respectively; and a controller calculating knocking intensity from the combustion pressure and the combustion pressure increasing rate, and controlling a gasoline fuel amount injected by the swirl gasoline injector and the tumble gasoline injector according to the knocking intensity.

### CROSS-REFERENCE TO RELATED APPLICATION

This application claims priority to and the benefit of Korean Patent Application No. 10-2016-0145020, filed in the Korean Intellectual Property Office on Nov. 2, 2016, the entire contents of which are incorporated herein by reference.

### BACKGROUND

### (a) Field

The present disclosure relates to an apparatus and a method for controlling a gasoline-diesel complex combustion engine. More particularly, the present disclosure relates to an apparatus and a method for controlling a gasoline-diesel complex combustion engine that is driven by using a mixture of a gasoline fuel and a diesel fuel.

### (b) Description of the Related Art

A diesel engine may have excellent fuel efficiency, but exhausts a lot of pollutants such as nitrogen oxides (NOx) and the like. On the other hand, a gasoline engine has relatively lower fuel efficiency, but exhausts fewer pollutants such as nitrogen oxides (NOx) and the like as compared with the diesel engine.

Recently, exhaust gas regulations for diesel engine vehicles have been tightened, so development of a novel diesel engine has been required.

As an example of the novel diesel engine, a gasoline-diesel complex combustion engine that is driven by using a mixture of a gasoline fuel and a diesel fuel is under development.

The gasoline-diesel complex combustion engine takes in a mixture gas of which the gasoline fuel and air are premixed in an intake stroke and injects the diesel fuel to control ignition in a compression stroke. Then, the diesel fuel is compressed and thus ignited in the compression stroke. At this time, the gasoline fuel is also ignited. Finally, the diesel fuel and the gasoline fuel are combusted in an explosion stroke, thereby generating driving power. However, the gasoline fuel and the diesel fuel may be ignited by using a spark plug depending on a proportion of the gasoline fuel and the diesel fuel.

The gasoline-diesel complex combustion engine has a high compression ratio compared to a general gasoline engine. In order to prevent early ignition of gasoline fuel injected into a combustion chamber under a high compression ratio, a method for increasing an exhaust gas recirculation (EGR) ratio by an EGR apparatus is used.

However, if the EGR ratio is increased, a fresh air amount supplied to the combustion chambers of the engine is reduced such that a driving region of the engine is limited.

The above information disclosed in this Background section is only for enhancement of understanding of the background and therefore it may contain information that does not form the prior art that is already known in this country to a person of ordinary skill in the art.

### SUMMARY

The present disclosure has been made in an effort to provide an apparatus and a method for controlling a gasoline-diesel complex combustion engine that can expand a driving region of the engine by reducing an EGR ratio and increasing a fresh air amount supplied to the engine.

An apparatus for controlling a gasoline-diesel complex combustion engine according to an exemplary embodiment may include: an engine generating driving torque by burning gasoline fuel and diesel fuel; a driving information detector for detecting driving information including an engine speed, combustion pressure in a combustion chamber, and a combustion pressure increasing rate; a swirl pipe disposed in the combustion chamber such that a flow of gasoline fuel introduced through the swirl pipe generates a flow in a swirl direction in the combustion chamber; a tumble pipe disposed in the combustion chamber such that a flow of gasoline fuel introduced through the tumble pipe generates a flow in a tumble direction in the combustion chamber; a swirl gasoline injector and a tumble gasoline injector disposed in the swirl pipe and the tumble pipe for injecting gasoline fuel into the combustion chamber, respectively; and a controller calculating knocking intensity from the combustion pressure and the combustion pressure increasing rate, and controlling a gasoline fuel amount injected by the swirl gasoline injector and the tumble gasoline injector according to the knocking intensity.

The controller may control such that injection of gasoline fuel by the tumble gasoline injection is stopped and injection of gasoline fuel by the swirl gasoline injector is increased when the knocking intensity is greater than a predetermined intensity.

The controller may calculate the knocking intensity from a maximum combustion pressure, a combustion pressure increasing rate, and an engine speed.

The knocking intensity may be calculated from an equation of:

$$R I = f ( M P R R , R P M , {P}_{max} ) = 2.88 * {10}^{- 8} * \frac{{( M P R R * R P M )}^{2}}{{P}_{max}} ,$$

wherein MPRR denotes the combustion pressure increasing rate, RPM denotes the engine speed, and Pₘₐₓ denotes the maximum combustion pressure.

A method for controlling a gasoline-diesel complex combustion engine according to another exemplary embodiment may include detecting driving information including an engine speed, a combustion pressure, and a combustion pressure increasing rate by a driving information detector; calculating a knocking intensity from the driving information by a controller; and controlling a gasoline fuel amount injected by a tumble gasoline injector disposed in a tumble pipe and a swirl gasoline injector disposed in a swirl pipe according to the knocking intensity by the controller.

Injection of gasoline fuel by the tumble gasoline injector may be stopped and injection of gasoline fuel by the swirl gasoline injector may be increased when the knocking intensity is greater than a predetermined intensity.

The knocking intensity may be calculated from a maximum combustion pressure, a combustion pressure increasing rate, and an engine speed.

The knocking intensity may be calculated from an equation of

$$R I = f ( M P R R , R P M , {P}_{max} ) = 2.88 * {10}^{- 8} * \frac{{( M P R R * R P M )}^{2}}{{P}_{max}} ,$$

wherein MPRR denotes the combustion pressure increasing rate, RPM denotes the engine speed, and Pₘₐₓ denotes the maximum combustion pressure.

According to an exemplary embodiment, since gasoline fuel is stratified by adjusting a gasoline fuel amount injected by a gasoline injector disposed in a tumble pipe and a swirl pipe according to a knocking intensity, an EGR ratio is increased such that a driving region of the gasoline-diesel complex combustion engine can be expanded.

Further, since a gasoline fuel is injected to be stratified, it is possible to prevent early ignition and abnormal combustion such as knocking in the combustion chamber.

### BRIEF DESCRIPTION OF THE DRAWINGS

The drawings are provided for reference in describing exemplary embodiments, and the spirit of the present disclosure should not be construed only by the accompanying drawings.

FIG. 1 is a schematic view illustrating an apparatus for controlling a gasoline-diesel complex combustion engine according to an exemplary embodiment.

FIG. 2 is a side view illustrating an intake pipe and an exhaust pipe according to an exemplary embodiment.

FIG. 3 is a top plan view illustrating an intake pipe and an exhaust pipe according to an exemplary embodiment.

FIG. 4 is a flowchart illustrating a method for controlling a gasoline-diesel complex combustion engine according to an exemplary embodiment.

The symbols in the Figures include the following elements: 100 refers to an engine; 110 refers to a combustion chamber, 120 refers to a cylinder head, 130 refers to a diesel injector, 150 refers to a swirl pipe, 151 refers to an end portion 151 of the swirl pipe, 152 refers to a swirl gasoline injector, 160 refers to a tumble pipe, 162 refers to a tumble gasoline injector, 170 refers to an exhaust pipe, 200 refers to a driving information detector, and 300 refers to a controller.

### DETAILED DESCRIPTION OF THE EMBODIMENTS

The present disclosure will be described more fully hereinafter with reference to the accompanying drawings, in which exemplary embodiments are shown. As those skilled in the art would realize, the described embodiments may be modified in various different ways, all without departing from the spirit or scope of the present disclosure.

To describe the present disclosure, parts that are irrelevant to the description are omitted, and like numerals refer to like or similar constituent elements throughout the specification.

Further, in the drawings, a size and thickness of each element are randomly represented for better understanding and ease of description, and the present disclosure is not limited thereto.

Hereinafter, an apparatus for controlling a gasoline-diesel complex combustion engine will be in detail with reference to the accompanying drawings.

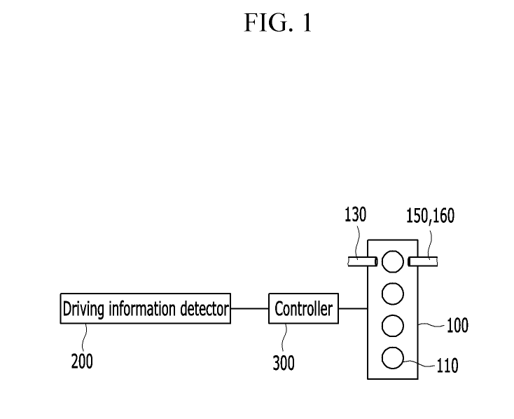

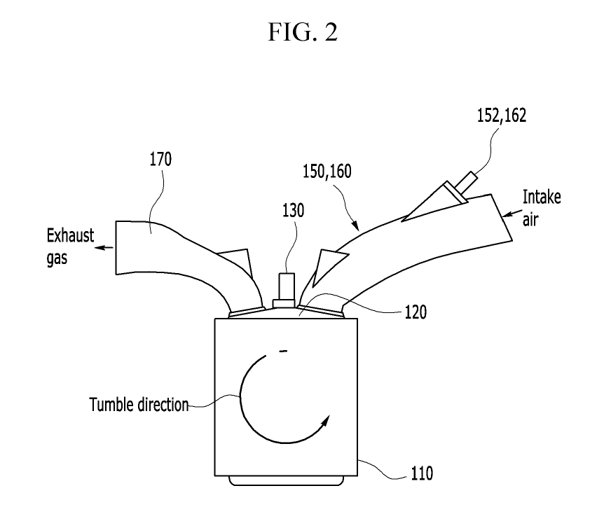

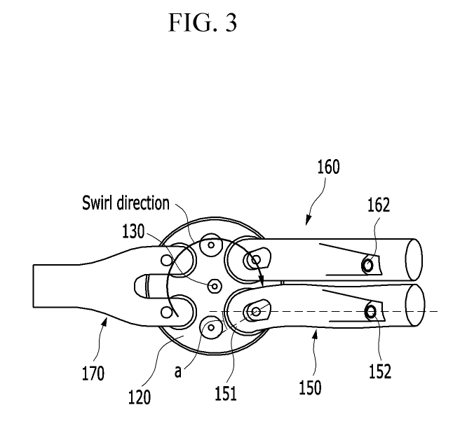

FIG. 1 is a schematic view illustrating an apparatus for controlling a gasoline-diesel complex combustion engine according to an exemplary embodiment. FIG. 2 is a side view illustrating an intake pipe and an exhaust pipe according to an exemplary embodiment. FIG. 3 is a top plan view illustrating an intake pipe and an exhaust pipe according to an exemplary embodiment.

As shown in FIG. 1 to FIG. 3, an apparatus for controlling a gasoline-diesel complex combustion engine according to an exemplary embodiment includes an engine 100 including a plurality of combustion chambers 110 generating driving torque by burning fuel, a diesel injector 130 injecting diesel fuel into the combustion chamber 110, a gasoline injector injecting gasoline fuel into the combustion chamber 110, a driving information detector 200 detecting driving information, and a controller 300 controlling operations of the engine 100, the diesel injector 130, and the gasoline injector.

The driving information detected by the driving information detector 200 includes an engine speed, a combustion pressure in the combustion chamber 110, and a combustion pressure increasing rate (e.g., maximum pressure rising rate (MPRR)). The engine speed may be detected through rotation speed of a crankshaft, and the combustion pressure and the combustion pressure increasing rate may be detected by a combustion pressure sensor. That is, the driving information detector 200 includes a speed sensor detecting the rotation speed of the crankshaft, and the combustion pressure sensor. The driving information detected by the driving information detector 200 is transmitted to the controller 300.

A swirl pipe 150 is disposed in the combustion chamber 110, and a flow of gasoline fuel introduced through the swirl pipe 150 generates a flow in a swirl direction in the combustion chamber 110. A gasoline injector for injecting gasoline fuel into the combustion chamber 110 is disposed in the swirl pipe 150 (hereinafter also referred to as “swirl gasoline injector 152”).

As shown in FIG. 2, the swirl pipe 150 is obliquely formed at a predetermined angle in the upward direction of a cylinder head 120 and in the opposite direction to an exhaust pipe 170 in the side view. Further, as shown in FIG. 3, the swirl pipe 150 extends substantially linearly in the opposite direction to the exhaust pipe 170 in the plane view. Herein, an end portion 151 of the swirl pipe 150 is externally obliquely formed at a predetermined angle ‘a’ in a radial direction from the center of a cylinder head 120.

Accordingly, the air and the gasoline fuel introduced through the swirl pipe 150 generate a flow in a swirl direction in the combustion chamber 110 since an end portion 151 is externally obliquely formed at a predetermined angle in the radial direction from the center of the cylinder head 120.

A tumble pipe 160 is disposed in the combustion chamber 110, and a flow of gasoline fuel introduced through the tumble pipe 160 generates a flow in a tumble direction in the combustion chamber 110. A gasoline injector for injecting gasoline fuel into the combustion chamber 110 is disposed in the tumble pipe 160 (hereinafter also referred to as “tumble gasoline injector 162”).

As shown in FIG. 2, the tumble pipe 160 is obliquely formed at a predetermined angle in the upward direction of the cylinder head 120 and in the opposite direction to the exhaust pipe 170 in the side view. Further, as shown in FIG. 3, the tumble pipe 160 extends substantially linearly in the opposite direction to the exhaust pipe 170 in the plane view.

Accordingly, the air and the gasoline fuel introduced through the tumble pipe 160 generate a flow in a tumble direction in the combustion chamber 110 since the tumble pipe 160 is obliquely formed at a predetermined angle in the upward direction of the cylinder head 120 and in the opposite direction to the exhaust ports 127 in the side view and extends substantially linearly in the opposite direction to the exhaust pipe 170 in the plane view.

The controller 300 can be realized by one or more processors activated by a predetermined program, and the predetermined program can be programmed to perform each act of a method for controlling a gasoline-diesel complex combustion engine according to an embodiment.

The controller 300 calculates a knocking intensity (e.g., rising intensity (RI)) from the driving information. The controller 300 controls a gasoline fuel amount injected by the swirl gasoline injector 152 and the tumble gasoline injector 162 according to the knocking intensity.

In detail, when the knocking intensity is greater than a predetermined intensity, the controller 300 controls the gasoline fuel injected by the tumble gasoline injector 162 to be stopped and gasoline amount injected by the swirl gasoline injector 152 to be increased. Accordingly, since gasoline fuel is not injected by the tumble gasoline injector 162 and gasoline fuel amount injected by the swirl gasoline injector 152 is increased, a stratification phenomenon in which gasoline fuel swirls in an upper portion of the combustion chamber 110 is generated.

When gasoline fuel is stratified in the combustion chamber 110, it is possible to prevent the gasoline fuel from early ignition during a compression stroke. Therefore, an EGR ratio can be reduced and a fresh air amount supplied to the combustion chamber is increased. Accordingly, a driving region of the gasoline-diesel complex combustion engine is expanded, and abnormal combustion (e.g., knocking) in the combustion chamber 110 is prevented.

According to an exemplary embodiment, knocking intensity (in other words, rising intensity (RI)) is used in order to predict generation of knocking. The knocking intensity may be calculated from a maximum combustion pressure (Pmax) of the engine, a combustion pressure increasing rate (MPRR) (bar/deg), and an engine speed (revolutions per minute (RPM)).

The knocking intensity (RI) may be calculated from Equation 1.

$$R I = f ( M P R R , R P M , {P}_{max} ) = 2.88 * {10}^{- 8} * \frac{{( M P R R * R P M )}^{2}}{{P}_{max}} \qquad ( 1 )$$

Herein, in Equation 1, MPRR denotes the combustion pressure increasing rate, RPM denotes the engine speed, and Pₘₐₓ denotes the maximum combustion pressure.

Since there is a low probability of knocking by early ignition of gasoline fuel in the combustion chamber 110 when the knocking intensity is less than a predetermined intensity, the controller 300 controls the gasoline fuel to be normally injected by the tumble gasoline injector 162 and the swirl gasoline injector 152.

However, there is a high probability of knocking by early ignition of gasoline fuel in the combustion chamber 110 when the knocking intensity is greater than the predetermined intensity, so the controller 300 controls the injection of gasoline fuel by the tumble gasoline injector 162 to be stopped and the gasoline fuel amount injected by the swirl gasoline injector 152 to be increased. Accordingly, gasoline fuel is stratified in the combustion chamber 110.

Hereinafter, a method for controlling the gasoline-diesel complex combustion engine according to an exemplary embodiment will be described in detail with reference to accompanying drawings.

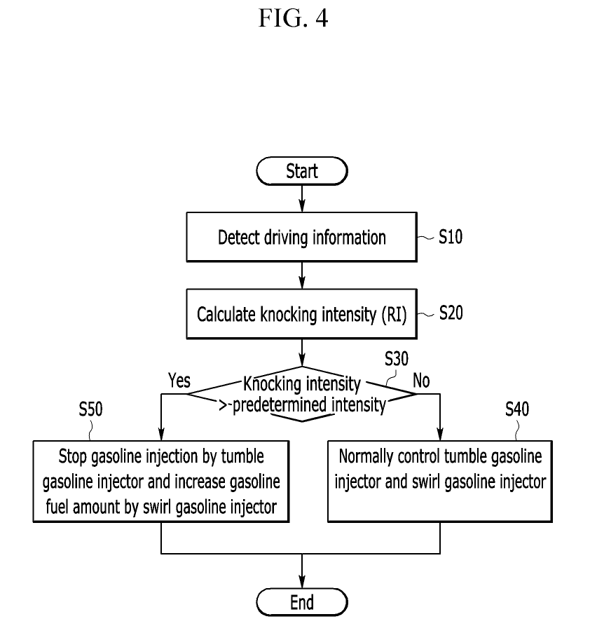

FIG. 4 is a flowchart illustrating a method for controlling a gasoline-diesel complex combustion engine according to an exemplary embodiment.

As shown in FIG. 4, the driving information detector 200 detects driving information including an engine speed, a combustion pressure, and a combustion pressure increasing rate, and the driving information is transmitted to the controller 300 at act S10.

The controller 300 calculates a knocking intensity from the driving information at act S20. The knocking intensity is used to predict a probability of knocking in the combustion chamber 110, and a detailed calculation method of the knocking intensity is the same as in the above description.

The controller 300 compares the knocking intensity to a predetermined intensity (e.g., 5 MW/m²) at act S30, and the controller 300 determines that the probability of knocking in the combustion chamber 110 is low when the knocking intensity is less than the predetermined intensity. Accordingly, the controller 300 controls the gasoline fuel to be normally injected by the tumble gasoline injector 162 and the swirl gasoline injector 152 at act S40.

In act S30, the controller 300 determines that the probability of knocking in the combustion chamber 110 is high when the knocking intensity is greater than the predetermined intensity, and the controller controls injection of gasoline fuel by the tumble gasoline injector 162 to be stopped and the gasoline fuel amount injected by the swirl gasoline injector 152 to be increased at act S50. Accordingly, gasoline fuel is stratified in the combustion chamber 110.

As described above, according to an exemplary embodiment, the gasoline fuel amount is adjusted by the tumble gasoline injector 162 and the swirl gasoline injector 152 according to the knocking intensity such that knocking by early ignition in the combustion chamber 110 can be prevented.

Further, it is not necessary to increase the EGR ratio in order to prevent early ignition of gasoline fuel, and thus it is possible to increase an amount of fresh air supplied to the combustion chamber 110 and expand the driving region of the gasoline-diesel complex combustion engine.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

What is claimed is:

1. An apparatus for controlling a gasoline-diesel complex combustion engine, the apparatus comprising:
an engine configured to generate driving torque by burning gasoline fuel and diesel fuel;
a driving information detector configured to detect driving information including an engine speed, combustion pressure in a combustion chamber, and a combustion pressure increasing rate;
a swirl pipe disposed in the combustion chamber, wherein a flow of gasoline fuel introduced through the swirl pipe is configured to generate a flow in a swirl direction in the combustion chamber;
a tumble pipe disposed in the combustion chamber, wherein a flow of gasoline fuel introduced through the tumble pipe is configured to generate a flow in a tumble direction in the combustion chamber;
a swirl gasoline injector and a tumble gasoline injector disposed in the swirl pipe and the tumble pipe, wherein the swirl gasoline injector and the tumble gasoline injector are respectively configured to inject the gasoline fuel into the combustion chamber; and
a controller configured to calculate a knocking intensity from the combustion pressure and the combustion pressure increasing rate, and control an amount of the gasoline fuel injected by the swirl gasoline injector and the tumble gasoline injector based on the calculated knocking intensity.

2. The apparatus of claim 1, wherein the controller is configured to stop injection of the gasoline fuel by the tumble gasoline injection and increase injection of the gasoline fuel by the swirl gasoline injector when the calculated knocking intensity is greater than a predetermined intensity.

3. The apparatus of claim 1, wherein the controller calculates the knocking intensity from a maximum combustion pressure, a combustion pressure increasing rate, and an engine speed.

4. The apparatus of claim 3, wherein the knocking intensity is calculated from an equation of:
$$R I = f ( M P R R , R P M , {P}_{max} ) = 2.88 * {10}^{- 8} * \frac{{( M P R R * R P M )}^{2}}{{P}_{max}} ,$$
wherein:
MPRR denotes the combustion pressure increasing rate,
RPM denotes the engine speed, and
Pₘₐₓ denotes the maximum combustion pressure.

5. The apparatus of claim 1, wherein the swirl pipe is obliquely positioned at a predetermined angle in an upward direction of a cylinder head of the combustion chamber

6. The apparatus of claim 5, wherein an end portion of the swirl pipe is externally obliquely positioned at the predetermined angle in a radial direction from a center of the cylinder head.

7. The apparatus of claim 1, wherein the swirl pipe is positioned in an opposite direction of an exhaust pipe of the apparatus.

8. The apparatus of claim 7, wherein the swirl pipe extends linearly in the opposite direction of the exhaust pipe.

9. The apparatus of claim 1, wherein the tumble pipe is obliquely positioned at a predetermined angle in an upward direction of a cylinder head of the combustion chamber.

10. The apparatus of claim 1, wherein the tumble pipe is positioned in an opposite direction of an exhaust pipe of the apparatus.

11. The apparatus of claim 10, wherein the tumble pipe extends linearly in the opposite direction of the exhaust pipe.

12. A method for controlling a gasoline-diesel complex combustion engine, the method comprising:
detecting, by a driving information detector, driving information including an engine speed, a combustion pressure, and a combustion pressure increasing rate;
calculating, by a controller, a knocking intensity from the driving information; and
controlling, by the controller, an amount of gasoline fuel amount by a tumble gasoline injector disposed in a tumble pipe and a swirl gasoline injector disposed in a swirl pipe, based on the calculated knocking intensity.

13. The method of claim 12, wherein the controller stops injection of the gasoline fuel by the tumble gasoline and increases injection of the gasoline fuel by the swirl gasoline injector when the calculated knocking intensity is greater than a predetermined intensity.

14. The method of claim 12, wherein the knocking intensity is calculated from a maximum combustion pressure, a combustion pressure increasing rate, and an engine speed.

15. The method of claim 14, wherein the knocking intensity is calculated from an equation of:
$$R I = f ( M P R R , R P M , {P}_{max} ) = 2.88 * {10}^{- 8} * \frac{{( M P R R * R P M )}^{2}}{{P}_{max}} ,$$
wherein:
MPRR denotes the combustion pressure increasing rate,
RPM denotes the engine speed, and
Pₘₐₓ denotes the maximum combustion pressure.
